(19) United States
(12) Patent Application Publication
(10) Pub. No.: US 2018/0372583 A1
(43) Pub. Date: Dec. 27, 2018

(54) MANUFACTURING FACILITY ANOMALY DIAGNOSTIC DEVICE

(71) Applicant: TOSHIBA MITSUBISHI-ELECTRIC INDUSTRIAL SYSTEMS CORPORATION, Chuo-ku (JP)

(72) Inventors: Tomoyuki TEZUKA, Tokyo (JP); Hiroyuki SHINONAGA, Tokyo (JP); Wataru KAMEYAMA, Tokyo (JP); Mutsumi SUGANUMA, Tokyo (JP); Motoki NAGASHIMA, Tokyo (JP)

(73) Assignee: TOSHIBA MITSUBISHI-ELECTRIC INDUSTRIAL SYSTEMS CORPORATION, Chuo-ku (JP)

(21) Appl. No.: 15/781,724

(22) PCT Filed: Feb. 25, 2016
(86) PCT No.: PCT/JP2016/055589

§ 371 Date: Jun. 6, 2018

(51) Int. Cl. G01M 13/00

(52) U.S. Cl. CPC G01M 13/00

(57) ABSTRACT

There is provided a manufacturing facility anomaly diagnostic device that makes it possible to perform anomaly diagnosis of a manufacturing facility. The anomaly diagnostic device includes a feature value storage unit configured to hold information of a feature value that captures an operation state of a manufacturing facility, a data conversion unit configured to convert data, a feature value analysis unit configured to analyze the data converted by the data conversion unit, a data restoration unit configured to restore the data, an anomaly degree calculation unit configured to calculate an anomaly degree, and an anomaly diagnostic unit configured to perform anomaly diagnosis.

### FIELD

The present invention relates to a manufacturing facility anomaly diagnostic device.

### BACKGROUND

PTL 1 discloses a manufacturing facility anomaly diagnostic device. The anomaly diagnostic device compares monitor data and normal data of the manufacturing facility to perform anomaly diagnosis.

### CITATION LIST

### Patent Literature

### [PTL 1] JP 2013-214292 A

### SUMMARY

### Technical Problem

In a case where various controls are gathered in a manufacturing facility, operation of the manufacturing facility becomes complicated. Therefore, the anomaly diagnostic device described in PTL 1 performs anomaly diagnosis with use of data in a state where the manufacturing facility is limited.

The present invention is made to solve the above-described problem. An object of the present invention is to provide a manufacturing facility anomaly diagnostic device that makes it possible to perform anomaly diagnosis of a manufacturing facility irrespective of a state of the manufacturing facility.

### Solution to Problem

A manufacturing facility anomaly diagnostic device according to the present invention includes a feature value storage unit configured to hold information of a feature value that captures an operation state of a manufacturing facility, a data conversion unit configured to convert data that includes operation data of the manufacturing facility or measurement data of a measurement device provided in the manufacturing facility, a feature value analysis unit configured to analyze the data converted by the data conversion unit, based on the information of the feature value held by the feature value storage unit, a data restoration unit configured to restore the data, based on the information of the feature value held by the feature value storage unit and information of a result of the analysis by the feature value analysis unit, a anomaly degree calculation unit configured to calculate a anomaly degree, based on the data used in the analysis by the feature value analysis unit and the data restored by the data restoration unit, and a anomaly diagnostic unit configured to perform anomaly diagnosis, based on the anomaly degree calculated by the anomaly degree calculation unit.

### Advantageous Effects of Invention

According to the present invention, the anomaly diagnosis is performed based on the anomaly degree that has been calculated based on the data used in the analysis by the feature value analysis unit and the data restored by the data restoration unit. This makes it possible to perform the anomaly diagnosis of the manufacturing facility irrespective of the state of the manufacturing facility.

### BRIEF DESCRIPTION OF DRAWINGS

FIG. 1 is a configuration diagram of a hot strip finishing mill to which a manufacturing facility anomaly diagnostic device according to a first embodiment of the present invention is applied.

FIG. 2 is a diagram to explain a method of anomaly diagnosis by the manufacturing facility anomaly diagnostic device according to the first embodiment of the present invention.

FIG. 3 is a flowchart to explain operation of the manufacturing facility anomaly diagnostic device according to the first embodiment of the present invention.

FIG. 4 is a hardware configuration diagram of the manufacturing facility anomaly diagnostic device according to the first embodiment of the present invention.

FIG. 5 is a configuration diagram of a hot strip finishing mill to which a manufacturing facility anomaly diagnostic device according to a second embodiment of the present invention is applied.

FIG. 6 is a diagram to explain an example of feature value extraction by the manufacturing facility anomaly diagnostic device according to the second embodiment of the present invention.

### DESCRIPTION OF EMBODIMENTS

Some embodiments of the present invention are described with reference to accompanying drawings. Note that, in the drawings, the same parts or substantially the same parts are denoted by the same reference numerals. Redundant description of the parts is appropriately simplified or omitted.

### First Embodiment

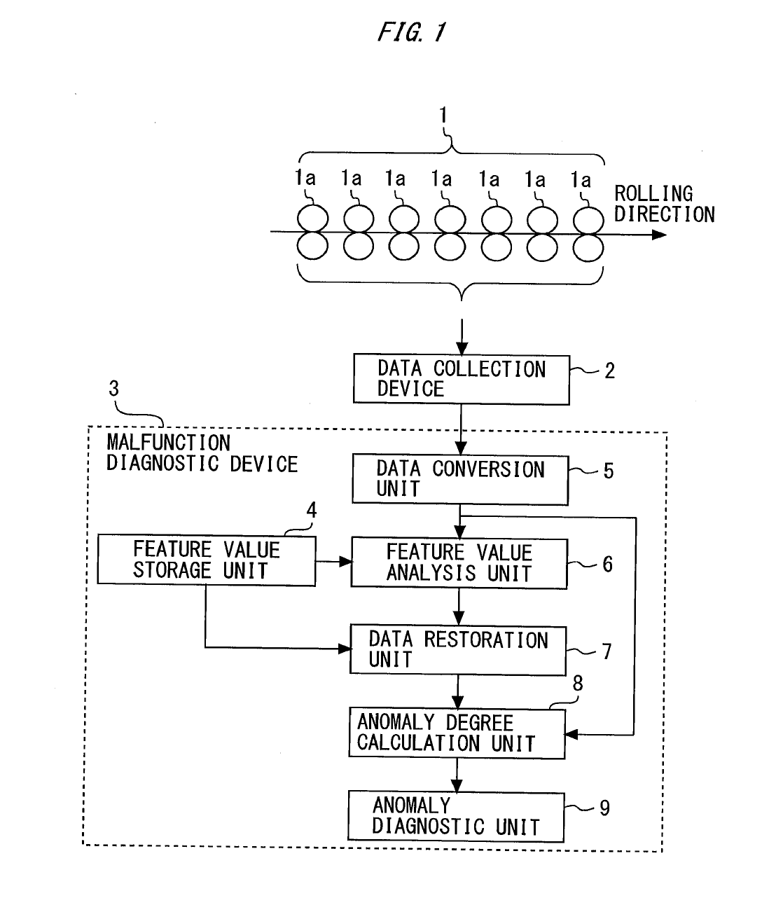

FIG. 1 is a configuration diagram of a hot strip finishing mill to which a manufacturing facility anomaly diagnostic device according to a first embodiment of the present invention is applied.

In FIG. 1, a hot strip finishing mill 1 is schematically illustrated. For example, the hot strip finishing mill 1 includes seven rolling mills 1a. Measurement devices including sensors, such as a thickness gauge and a shape measurement device are not illustrated. A material flows in an illustrated rolling direction. As a result, the material is rolled to a desired thickness by the seven rolling mills 1a.

A data collection device 2 periodically or intermittently collects data that includes operation data of the hot strip finishing mill 1 or measurement data of the measurement devices. For example, the data collection device 2 collects data of set up values of the actuators in the hot strip finishing mill 1. For example, the data collection device 2 collects data of actual values of the actuators in the hot strip finishing mill 1. For example, the data collection device 2 collects data of measured values by the sensors. For example, the data collection device 2 collects data of manipulated amount by a control system to obtain a desired product.

An anomaly diagnostic device 3 includes a feature value storage unit 4, a data conversion unit 5, a feature value analysis unit 6, a data restoration unit 7, an anomaly degree calculation unit 8, and an anomaly diagnostic unit 9.

The feature value storage unit 4 holds information of a feature value that captures a normal operation state of the manufacturing facility based on the data collected by the data collection device 2. The feature value is extracted in advance. For example, the feature value is extracted by a method using principal component analysis. Principal components are extracted as the feature value by the method using principal component analysis. For example, the feature value is extracted by a method using sparse coding. A set of bases is extracted as the feature value by the method using sparse coding.

A magnitude of the value is varied among the data used for the feature value extraction. When the variation is large, deviation occurs on the feature value extraction. Therefore, normalization processing is performed on the collected data before the feature value extraction. For example, the normalization processing is expressed by the following equation (1) based on an average value and a standard deviation of the data used for the feature value extraction.

$$\begin{matrix}[ Math . 1 ] & \\ {x}_{ik}^{′} = \frac{{x}_{ik} - {x}_{avei}}{{σ}_{i}} & ( 1 )\end{matrix}$$

In the equation, x′ᵢₖ is a value of i-th data after k-th normalization, xᵢₖ is a value of the i-th data before k-th normalization, xₐᵥₑᵢ is an average value of the i-th data, and σᵢ is a standard deviation of the i-th data.

Note that the normalization processing is effective to a case where the value is largely different by data. For example, in a case where first data has an order of 2.0, 3.0, etc. whereas second data has an order of thousands, performing the normalization processing is effective. Further, the normalization processing may be performed by a method other than the method using the equation (1). Moreover, the normalization processing may not be performed in a case where there is no problem even when the normalization is not performed.

In addition, filter processing using, for example, a low-pass filter may be performed before the normalization is performed in some cases. In this case, noise is removed.

For example, the feature value is stratified based on the operation state of the hot strip finishing mill 1. For example, the feature value is stratified into during rolling and during non-rolling. The information of the feature value is stored in association with information of the operation state of the hot strip finishing mill 1.

For example, the feature value is stratified based on a product to be manufactured. For example, the feature value is stratified based on steel grade, dimension, etc. of the material to be rolled. The information of the feature value is stored in association with information relating to the product to be manufactured.

The data conversion unit 5 converts data transmitted from the data collection device 2. For example, the data conversion unit 5 performs the normalization processing on the data transmitted from the data collection device 2, based on the average value and the standard deviation that are held by the feature value storage unit 4 and have been used for the extraction of the information of the feature value. In a case where the feature value is stratified in the feature value storage unit 4, the data conversion unit 5 uses the average value and the standard deviation that are obtained for each category corresponding to the stratification in the feature value storage unit 4. In the data conversion unit 5, filter processing using, for example, a low-pass filter may be performed before the normalization is performed. In this case, noise is removed. Note that the data is not converted in a case where there is no problem even when the data conversion is not performed.

The feature value analysis unit 6 receives data converted by the data conversion unit 5. The feature value analysis unit 6 analyzes the data converted by the data conversion unit 5, based on the information of the feature value held by the feature value storage unit 4. The analysis is performed by a method similar to the method in the feature value extraction. In the case where the feature value is extracted through the principal component analysis, an analysis result is a coefficient represented by the principal component. In the case where the feature value is extracted through the sparse coding, the analysis result corresponds to sparse coefficients. In the case where the information of the feature value is stratified in the feature value storage unit 4, the analysis is performed on the feature value corresponding to each category.

The data restoration unit 7 restores data, based on the information of the feature value held by the feature value storage unit 4 and the information of the analysis result of the feature value analysis unit 6. In the case where the information of the feature value is stratified by the feature value storage unit 4, the feature value corresponding to each category is used.

The anomaly degree calculation unit 8 calculates an anomaly degree, based on the data used in the analysis by the feature value analysis unit 6 and the data restored by the data restoration unit 7. For example, an absolute value of a difference in each data is calculated as the anomaly degree. For example, the square of the difference in each data is calculated as the anomaly degree.

The anomaly diagnostic unit 9 performs anomaly diagnosis, based on the anomaly degree calculated by the anomaly degree calculation unit 8. For example, when the anomaly degree calculated by the anomaly degree calculation unit 8 exceeds a preset threshold, the anomaly diagnostic unit 9 diagnoses that anomaly has occurred. For example, the threshold is set based on the restored data that is acquired in a manner similar to the above-described method using the data in the feature value extraction in advance. For example, the threshold is set to a maximum difference value between original data and the restored data. For example, the threshold is set to a value that causes 95% of the difference between the original data and the restored data to be within the range. In these cases, it is diagnosed as normal when the anomaly degree is within the threshold.

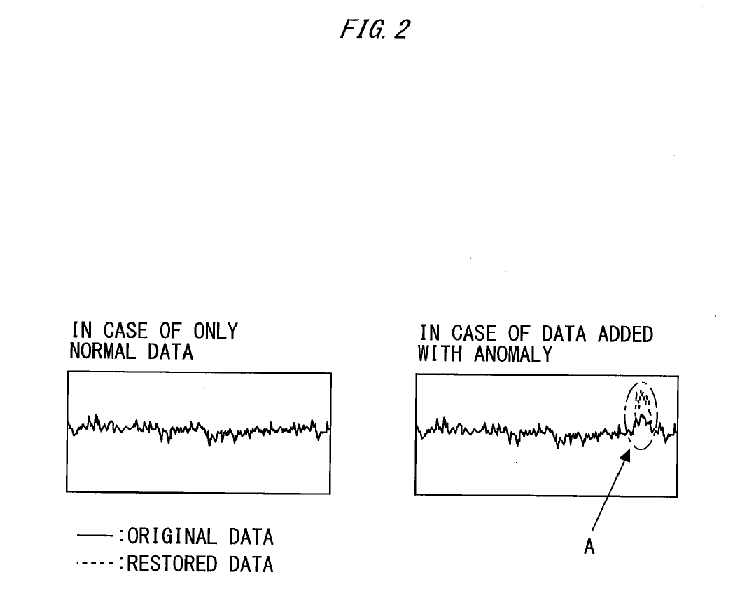

Next, the method of anomaly diagnosis is described with reference to FIG. 2.

FIG. 2 is a diagram to explain the method of anomaly diagnosis by the manufacturing facility anomaly diagnostic device according to the first embodiment of the present invention.

Left side in FIG. 2 illustrates a case of only normal data. As illustrated on the left side in FIG. 2, in the case of the normal data, the original data and the restored data are substantially coincident with each other. In this case, the anomaly diagnostic device 3 determines diagnosis as normal.

Right side in FIG. 2 illustrates a case of data added with anomaly. As illustrated on the right side in FIG. 2, data is not restored in an anomaly part A. This causes a difference between the original data and the restored data. In this case, the anomaly diagnostic device 3 determines diagnosis as anomaly.

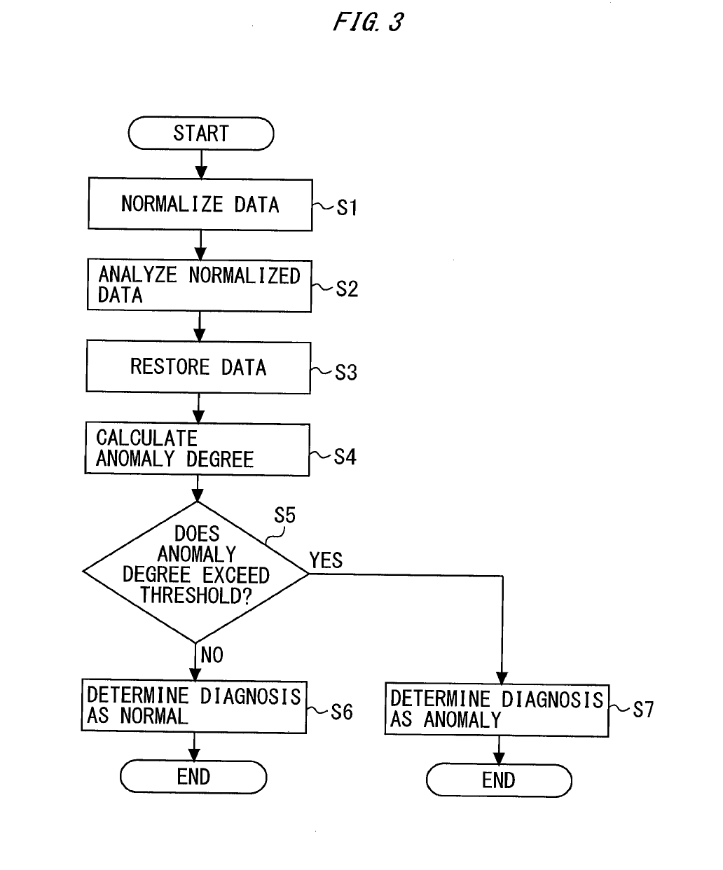

Next, operation of the anomaly diagnostic device is described with reference to FIG. 3.

FIG. 3 is a flowchart to explain operation of the manufacturing facility anomaly diagnostic device according to the first embodiment of the present invention.

In step S1, the data conversion unit 5 normalizes the data from the data collection device 2. Thereafter, the processing proceeds to step S2. In step S2, the feature value analysis unit 6 analyzes the data normalized by the data conversion unit 5, based on the information of the feature value held by the feature value storage unit 4. Thereafter, the processing proceeds to step S3. In step S3, the data restoration unit 7 restores the data, based on the information of the feature value held by the feature value storage unit 4 and the information of the analysis result of the feature value analysis unit 6.

Thereafter, the processing proceeds to step S4. In step S4, the anomaly degree calculation unit 8 calculates the anomaly degree, based on the data used in the analysis by the feature value analysis unit 6 and the data restored by the data restoration unit 7. Thereafter, the processing proceeds to step S5. In step S5, the anomaly diagnostic unit 9 performs the anomaly diagnosis, based on the anomaly degree calculated by the anomaly degree calculation unit 8. For example, the anomaly diagnostic unit 9 determines whether the anomaly degree calculated by the anomaly degree calculation unit 8 exceeds the preset threshold.

In a case where the anomaly degree calculated by the anomaly degree calculation unit 8 does not exceed the preset threshold in step S5, the processing proceeds to step S6. In step S6, the anomaly diagnostic unit 9 determines diagnosis as normal. Thereafter, the operation ends.

In a case where the anomaly degree calculated by the anomaly degree calculation unit 8 exceeds the preset threshold in step S5, the processing proceeds to step S7. In step S7, the anomaly diagnostic unit 9 determines diagnosis as anomaly. Thereafter, the operation ends.

According to the first embodiment described above, the anomaly diagnosis is performed based on the anomaly degree that has been calculated based on the data used in the analysis by the feature value analysis unit 6 and the data restored by the data restoration unit 7. This makes it possible to perform the anomaly diagnosis of the hot strip finishing mill 1 irrespective of the state of the hot strip finishing mill 1.

Further, the feature value analysis unit 6 performs analysis, based on the data normalized by the data conversion unit 5. Accordingly, even if variation among the data is large, it is possible to appropriately perform the anomaly diagnosis of the hot strip finishing mill 1.

Moreover, the anomaly diagnostic unit 9 performs the anomaly diagnosis through the comparison between the anomaly degree calculated by the anomaly degree calculation unit 8 and the preset threshold. At this time, it may be diagnosed as anomaly in a case where the anomaly degree exceeds the preset threshold a preset number of times within a preset period, in consideration of data fluctuation. In this case, it is possible to avoid wrong diagnosis due to data suddenly generated.

Further, the information of the feature value is stored in association with the information of the operation state of the hot strip finishing mill 1 in some cases. In this case, it is possible to enhance accuracy of the anomaly diagnosis of the hot strip finishing mill 1.

Furthermore, the information of the feature value is stored in association with the information relating to a product to be manufactured in some cases. In this case, it is possible to enhance accuracy of the anomaly diagnosis of the hot strip finishing mill 1.

Note that the information of the feature value may be stored in association with the information of the operation state of the hot strip finishing mill 1 and the information relating to the product to be manufactured. In this case, it is possible to further enhance accuracy of the anomaly diagnosis of the hot strip finishing mill 1.

Note that, in a case where the hot strip finishing mill 1 is diagnosed as anomaly, alarm may be notified to a maintenance worker. In this case, continuous monitoring by the maintenance worker becomes unnecessary. As a result, it is possible to reduce burden of the maintenance worker. Further, it is possible to perform maintenance work before a failure occurs. This makes it possible to prevent stoppage and serious accidents of the hot strip finishing mill 1 before they happen. As a result, it is possible to secure stable quality.

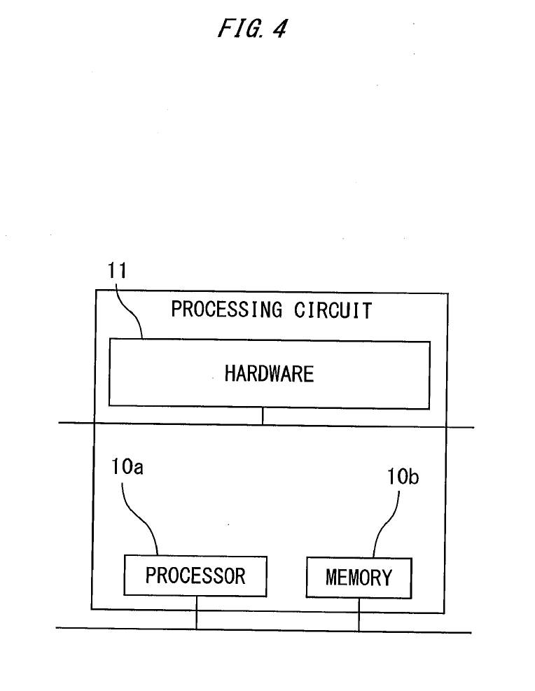

Next, an example of the anomaly diagnostic device 3 is described with reference to FIG. 4.

FIG. 4 is a hardware configuration diagram of the manufacturing facility anomaly diagnostic device according to the first embodiment of the present invention.

Each of the functions of the anomaly diagnostic device 3 is realizable by a processing circuitry. For example, the processing circuitry includes at least one processor 10a and at least one memory 10b. For example, the processing circuitry includes at least one dedicated hardware 11.

In a case where the processing circuitry includes the at least one processor 10a and the at least one memory 10b, each of the functions of the anomaly diagnostic device 3 is realized by software, firmware, or a combination of software and firmware. One or both of the software and the firmware are described as a program. One or both of the software and the firmware are stored in the at least one memory 10b. The at least one processor 10a reads and executes a program held by the at least one memory 10b, thereby realizing each of the functions of the anomaly diagnostic device 3. The at least one processor 10a is also referred to as a central processing unit (CPU), a central processor, a processor, a calculator, a microprocessor, a microcomputer, or DSP. Examples of the at least one memory 10b include a non-volatile or volatile semiconductor memory such as a RAM, a ROM, a flash memory, an EPROM, and an EEPROM, a magnetic disc, a flexible disc, an optical disc, a compact disc, a mini disc, a DVD, and the like.

In the case where the processing circuitry includes the at least one dedicated hardware 11, examples of the processing circuitry include a single circuit, a composite circuit, a programmed processor, a parallel programmed processor, an ASIC, an FPGA, and a combination thereof. For example, each of the functions of the anomaly diagnostic device 3 is realized by the corresponding processing circuitry. For example, the functions of the anomaly diagnostic device 3 is collectively realized by the processing circuitry.

A part of the functions of the anomaly diagnostic device 3 may be realized by the dedicated hardware 11 and the other part may be realized by software or firmware. For example, the function of the feature value storage unit 4 may be realized by a processing circuitry serving as the dedicated hardware 11, and the functions of the units other than the feature value storage unit 4 may be realized when the at least one processor 10a reads and executes programs held by the at least one memory 10b.

As described above, the processing circuitry realizes the functions of the anomaly diagnostic device 3 by the hardware 11, software, firmware, or a combination thereof.

### Second Embodiment

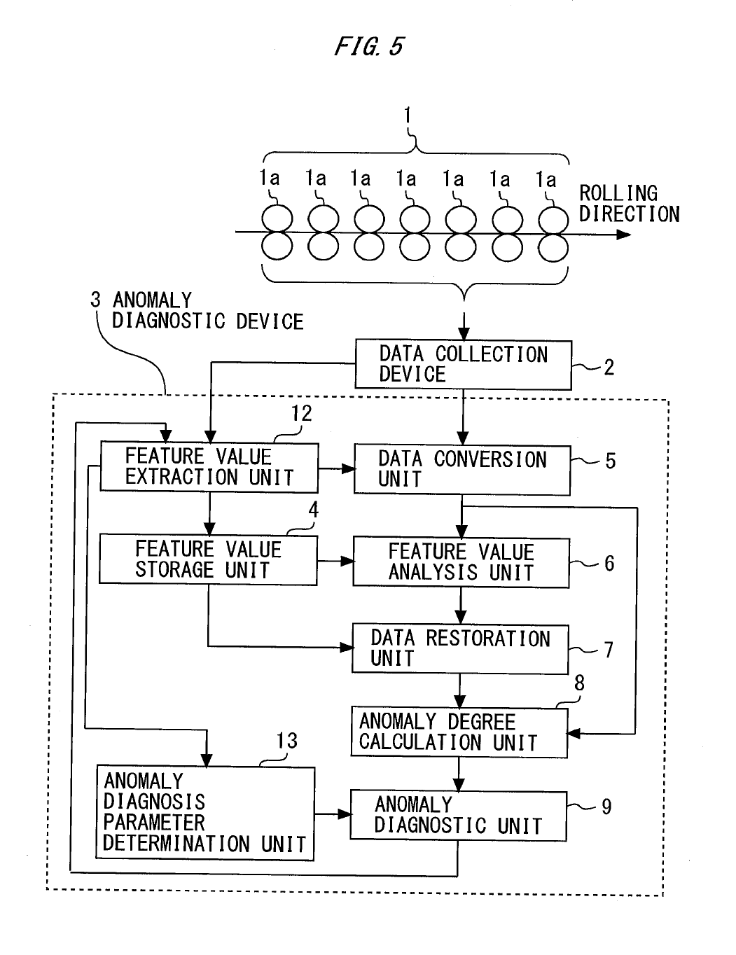

FIG. 5 is a configuration diagram of the hot strip finishing mill to which a manufacturing facility anomaly diagnostic device according to a second embodiment of the present invention is applied. Note that the same parts or substantially the same parts as those in the first embodiment are denoted by the same reference numerals. Description of the parts is omitted.

The anomaly diagnostic device 3 according to the second embodiment is an anomaly diagnostic device obtained by adding a feature value extraction unit 12 and an anomaly diagnosis parameter determination unit 13 to the anomaly diagnostic device 3 according to the first embodiment.

For example, the feature value extraction unit 12 periodically updates the information of the feature value held by the feature value storage unit 4. For example, the feature value extraction unit 12 updates the information of the feature value held by the feature value storage unit 4 at every event such as periodic repair of the hot strip finishing mill 1.

The feature value extraction unit 12 updates the information of the feature value by a method similar to the method in the feature value extraction by the feature value storage unit 4. In a case where the data collection device 2 has a function of accumulating data, the feature value extraction unit 12 uses the data in the data collection device 2 to update the information of the feature value. In a case where the data collection device 2 does not have the function of accumulating data, the feature value extraction unit 12 stores the data from the data collection device 2 to update the information of the feature value.

The feature value extraction unit 12 receives notification of a result of the anomaly diagnosis from the anomaly diagnostic unit 9. The feature value extraction unit 12 updates the information of the feature value held by the feature value storage unit 4 using only data diagnosed as normal by the anomaly diagnostic unit 9.

In the case where the information of the feature value is stratified in the feature value storage unit 4, the feature value corresponding to each category is updated.

The anomaly diagnosis parameter determination unit 13 receives data used for update of the feature value and the updated information of the feature value. The anomaly diagnosis parameter determination unit 13 determines a threshold to be used for the anomaly diagnosis, based on the data used for update of the feature value and the updated information of the feature value. The anomaly diagnosis parameter determination unit 13 determines the threshold by an automated method similar to the method of determining the threshold set to the anomaly diagnostic unit 9. The anomaly diagnosis parameter determination unit 13 notifies the anomaly diagnostic unit 9 of information of the threshold.

In the case where the information of the feature value is stratified in the feature value storage unit 4, the threshold value corresponding to each category is set.

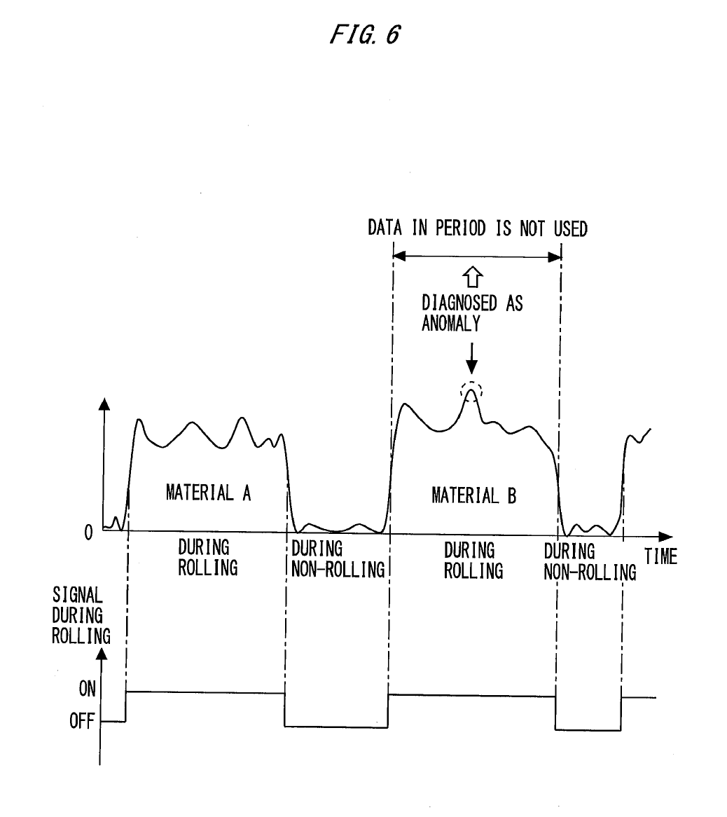

Next, an example of the feature value extraction by the anomaly diagnostic device is described with reference to FIG. 6.

FIG. 6 is a diagram to explain an example of the feature value extraction by the manufacturing facility anomaly diagnostic device according to the second embodiment of the present invention.

In FIG. 6, operation state is classified into “during rolling” and “during non-rolling”. During rolling of a material B, data diagnosed as anomaly exists. In this case, all of data in a period during the rolling of the material B is not used for update of the feature value.

According to the second embodiment described above, the information of the feature value held by the feature value storage unit 4 is updated. In addition, the parameters used for data conversion by the data conversion unit 5 is also updated. This makes it possible to perform anomaly diagnosis corresponding to change of the hot strip finishing mill 1 with time.

Further, the information of the feature value is updated with using only data diagnosed as normal. This makes it possible to set more suitable feature value.

Note that occurrence of actual anomaly may be started before diagnosis is determined as anomaly. Therefore, data in a certain period before and after the data concerned may not be used for update of the information of the feature value. Further, as illustrated in FIG. 6, all of data in a period including the data concerned may not be used for update of the information of the feature value, based on the information of the operation state or the information relating to a product to be manufactured.

Moreover, the threshold used by the anomaly diagnostic unit 9 is determined based on the updated information of the feature value. This makes it possible to set the threshold corresponding to change of the hot strip finishing mill 1 with time.

Note that the anomaly diagnostic device 3 according to the first embodiment or the second embodiment may be applied to a manufacturing facility that is different from the hot strip finishing mill 1. For example, the anomaly diagnostic device 3 according to the first embodiment or the second embodiment may be applied to a continuous cold rolling mill. For example, the anomaly diagnostic device 3 according to the first embodiment or the second embodiment may be applied to an annealing line. For example, the anomaly diagnostic device 3 according to the first embodiment or the second embodiment may be applied to a galvanizing process line.

### INDUSTRIAL APPLICABILITY

As described above, the manufacturing facility anomaly diagnostic device according to the present invention is usable for a system performing anomaly diagnosis of a manufacturing facility irrespective of a state of the manufacturing facility.

### REFERENCE SIGNS LIST

1 Hot strip finishing mill
1a Rolling mill
2 Data collection device
3 Anomaly diagnostic device
4 Feature value storage unit
5 Data conversion unit
6 Feature value analysis unit
7 Data restoration unit
8 Anomaly degree calculation unit
9 Anomaly diagnostic unit
10a Processor
10b Memory
11 Hardware
12 Feature value extraction unit
13 Anomaly diagnosis parameter determination unit

1. A manufacturing facility anomaly diagnostic device, comprising:
a feature value storage unit configured to hold information of a feature value that captures an operation state of a manufacturing facility;
a data conversion unit configured to convert data that includes operation data of the manufacturing facility or measurement data of a measurement device provided in the manufacturing facility;
a feature value analysis unit configured to analyze the data converted by the data conversion unit, based on the information of the feature value held by the feature value storage unit;
a data restoration unit configured to restore the data, based on the information of the feature value held by the feature value storage unit and information of a result of the analysis by the feature value analysis unit;
an anomaly degree calculation unit configured to calculate an anomaly degree, based on the data used in the analysis by the feature value analysis unit and the data restored by the data restoration unit; and
an anomaly diagnostic unit configured to perform anomaly diagnosis, based on the anomaly degree calculated by the anomaly degree calculation unit.

2. The manufacturing facility anomaly diagnostic device according to claim 1, wherein the data conversion unit normalizes the data that includes the operation data of the manufacturing facility or the measurement data of the measurement device provided in the manufacturing facility.

3. The manufacturing facility anomaly diagnostic device according to claim 1, wherein the anomaly diagnostic unit determines diagnosis as anomaly in a case where the anomaly degree calculated by the anomaly degree calculation unit exceeds a preset threshold a preset number of times within a preset period.

4. The manufacturing facility anomaly diagnostic device according to claim 1, wherein the feature value storage unit holds the information of the feature value in association with information of the operation state of the manufacturing facility.

5. The manufacturing facility anomaly diagnostic device according to claim 1, wherein the feature value storage unit holds the information of the feature value in association with information relating to a product to be manufactured.

6. The manufacturing facility anomaly diagnostic device according to claim 1, comprising a feature value extraction unit configured to update the information of the feature value held by the feature value storage unit, based on the data that includes the operation data of the manufacturing facility or the measurement data of the measurement device provided in the manufacturing facility.

7. The manufacturing facility anomaly diagnostic device according to claim 6, wherein the feature value extraction unit updates the information of the feature value held by the feature value storage unit using only data diagnosed as normal by the anomaly diagnostic unit.

8. The manufacturing facility anomaly diagnostic device according to claim 6, wherein the feature value extraction unit updates parameters used for conversion of the data by the data conversion unit, based on the data that includes the operation data of the manufacturing facility or the measurement data of the measurement device provided in the manufacturing facility.

9. The manufacturing facility anomaly diagnostic device according to claim 6, comprising an anomaly diagnosis parameter determination unit configured to determine the threshold used by the anomaly diagnostic unit, based on the information of the feature value updated by the feature value extraction unit.
